(19) United States
(12) Patent Application Publication
(10) Pub. No.: US 2026/0366688 A1
(43) Pub. Date: Nov. 19, 2026

(54) VEHICLE HEADLIGHT

(71) Applicant: KOITO MANUFACTURING CO., LTD., Tokyo (JP)

(72) Inventors: Shingo Kuroda, Shizuoka (JP); Masanori Kito, Shizuoka (JP)

(73) Assignee: KOITO MANUFACTURING CO., LTD., Tokyo (JP)

(21) Appl. No.: 19/470,520

(22) PCT Filed: Mar. 13, 2024
(86) PCT No.: PCT/JP2024/009709

§ 371 Date: Sep. 29, 2025

(30) Foreign Application Priority Data
Mar. 29, 2023 (JP) 2023-053554

(51) Int. Cl. F21S 41/43; F21S 41/143; F21S 41/151; F21S 41/24; F21S 41/25; F21S 41/32

(52) U.S. Cl. CPC F21S 41/43; F21S 41/143; F21S 41/151; F21S 41/24; F21S 41/25; F21S 41/32

(57) ABSTRACT

A vehicle headlamp includes an optical member that extends in a horizontal direction and a front-rear direction, a first light source, a second light source configured to cause light to be incident on the optical member, and a projection lens. The optical member includes a light guide portion configured to guide light from the second light source, and a first light blocking portion configured to block light emitted from the first light source from entering the light guide portion. A shade portion is provided at an end portion of the first light blocking portion on the projection lens side and near a focal point of the projection lens, the shade portion being configured to block a part of the light emitted from the first light source and incident on the projection lens to form a cutoff line in a light distribution pattern.

### TECHNICAL FIELD

The present disclosure relates to a vehicle headlamp.

### BACKGROUND ART

Patent Literature 1 discloses a vehicle lamp that switches between a low beam light distribution pattern and a high beam light distribution pattern with a single lamp. The vehicle lamp includes one projection lens, a plurality of light sources that emit light to the projection lens, and a shade that blocks a part of the light emitted from each of the plurality of light sources to form a cutoff line.

### CITATION LIST

### Patent Literature

Patent Literature 1: JP2015-149158A

### SUMMARY OF INVENTION

### Technical Problem

The cutoff line of the low beam light distribution pattern preferably has a clear contrast between brightness and darkness from the viewpoint of not giving glare to an oncoming vehicle or the like. On the other hand, in a case where a driver wants to see a dark region in the distance, if a contrast ratio between brightness and darkness is too large, it is difficult to see the dark region, and thus a cutoff line having a gentle gradient between brightness and darkness is preferable.

Therefore, an object of the present disclosure is to provide a vehicle headlamp capable of switching between a clear cutoff line and a blurred cutoff line while preventing an increase in the number of components.

### Solution to Problem

A vehicle headlamp according to an aspect of the present disclosure including:
an optical member that extends in a horizontal direction and a front-rear direction; a first light source;
a second light source configured to cause light to be incident on the optical member; and
a projection lens,
in which the optical member includes:
   a light guide portion configured to guide light from the second light source; and
   a first light blocking portion configured to block light emitted from the first light source from entering the light guide portion,
a shade portion is provided at an end portion of the first light blocking portion on the projection lens side and near a focal point of the projection lens, the shade portion being configured to block a part of the light emitted from the first light source and incident on the projection lens to form a cutoff line in a light distribution pattern, and
an emission surface of the light guide portion is provided near the shade portion so as to face the projection lens, and at least a part of light emitted from the second light source is emitted so as to overlap the cutoff line.

According to the above configuration, the light guide portion that guides the light from the second light source is integrally formed with the shade portion, so that an increase in the number of components is prevented. Further, the emission surface of the light guide portion is provided near the shade portion, so that the light from the second light source is easily emitted so as to overlap the cutoff line.

A vehicle headlamp according to another aspect of the present disclosure is a vehicle headlamp for emitting a light distribution pattern having a cutoff line, the vehicle headlamp including:
a first light source;
a second light source;
a partition unit that separates the first light source and the second light source; and
a projection lens,
wherein the partition unit includes:
   a third light source;
   a light guide portion configured to guide light from the third light source to the projection lens;
   a first light blocking portion that is provided on the first light source side of the light guide portion and that is configured to block light from the first light source from entering the light guide portion; and
   a second light blocking portion that is provided on the second light source side of the light guide portion and that is configured to block light from the second light source from entering the light guide portion; and
wherein at an end portion of the partition unit on the projection lens side, an emission surface of the light guide portion having a shape corresponding to the cutoff line is exposed between the first light blocking portion and the second light blocking portion, and light emitted from the third light source is emitted at least at a position overlapping the cutoff line.

According to the above configuration, the light guide portion that guides the light from the third light source is disposed in the partition unit that blocks the light from the first light source and the second light source, so that an increase in the size of the vehicle headlamp is prevented.

Further, the emission surface of the light guide portion is provided in the vicinity of the focal point of the projection lens, so that the shape of the emission surface can directly become the shape of the light distribution pattern formed by the light emitted from the third light source. Therefore, by forming the emission surface of the light guide portion in a shape corresponding to the cutoff line, a light distribution pattern that overlaps the cutoff line is easily formed by the light emitted from the third light source.

### Advantageous Effects of Invention

According to the present disclosure, it is possible to provide a vehicle headlamp capable of switching between a clear cutoff line and a blurred cutoff line while preventing an increase in the number of components.

### BRIEF DESCRIPTION OF DRAWINGS

FIG. 1 is a cross-sectional view illustrating a configuration of a vehicle headlamp according to the present embodiment.

FIG. 2 is a front view of an optical unit as viewed from an arrow II in FIG. 1.

FIG. 3 is a diagram illustrating a first irradiation region formed when a low light source of the vehicle headlamp is turned on.

FIG. 4 is a diagram illustrating a third irradiation region formed when an additional light source of the vehicle headlamp is turned on.

FIG. 5 is a diagram illustrating an irradiation region formed when the low light source and the additional light source of the vehicle headlamp are turned on.

FIG. 6 is a diagram illustrating a second irradiation region formed when a high light source of the vehicle headlamp is turned on.

FIG. 7 is a diagram illustrating an irradiation region formed when the low light source and the high light source of the vehicle headlamp are turned on.

FIG. 8 is a cross-sectional view illustrating a configuration of a vehicle headlamp according to a modification.

FIG. 9 is a front view of a projection lens in FIG. 8.

FIG. 10 is a diagram illustrating a low beam light distribution pattern emitted by the vehicle headlamp according to the modification.

### DESCRIPTION OF EMBODIMENTS

Hereinafter, embodiments of the present disclosure will be described with reference to the drawings. Members having the same reference numerals as those already described in the description of the embodiments will not be described for convenience of description. Further, for convenience of description, the dimensions of the members shown in the drawings may be different from actual dimensions of the members.

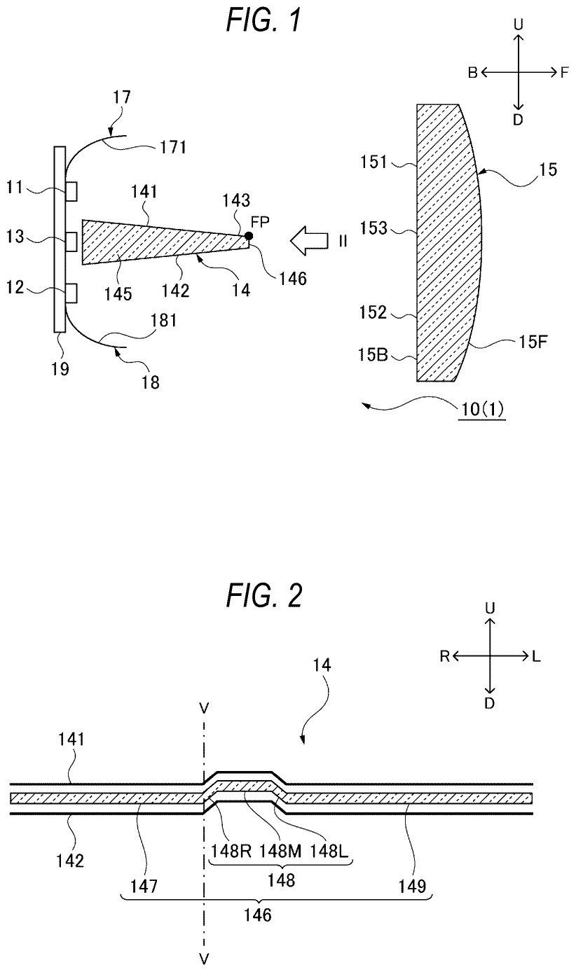

In the description of the present embodiment, a “left-right direction”, an “upper-lower direction”, and a “front-rear direction” may be appropriately referred to for convenience of description. The directions are relative directions set for a vehicle headlamp 10 illustrated in FIG. 1. Here, the “left-right direction” is a direction including a “left direction” and a “right direction”, and is also a vehicle width direction of a vehicle 1 on which the vehicle headlamp 10 is mounted. The “upper-lower direction” is a direction including an “upper direction” and a “lower direction”. The “front-rear direction” is a direction including a “front direction” and a “rear direction”. The front-rear direction is a direction orthogonal to the left-right direction and the upper-lower direction. In the drawings, a reference numeral U indicates the upper direction. A reference numeral D indicates the lower direction. A reference numeral F indicates the front direction. A reference numeral B indicates the rear direction. A reference numeral L indicates the left direction. A reference numeral R indicates the right direction. The left-right direction is an example of a horizontal direction.

### First Embodiment

A vehicle headlamp 10 according to the present embodiment will be described with reference to FIG. 1.

FIG. 1 is a cross-sectional view illustrating a configuration of the vehicle headlamp 10 according to the present embodiment. As illustrated in FIG. 1, the vehicle headlamp 10 includes a low light source 11, an additional light source 13, an optical unit 14, a projection lens 15, a first reflector 17, and a base 19. Hereinafter, each component will be described.

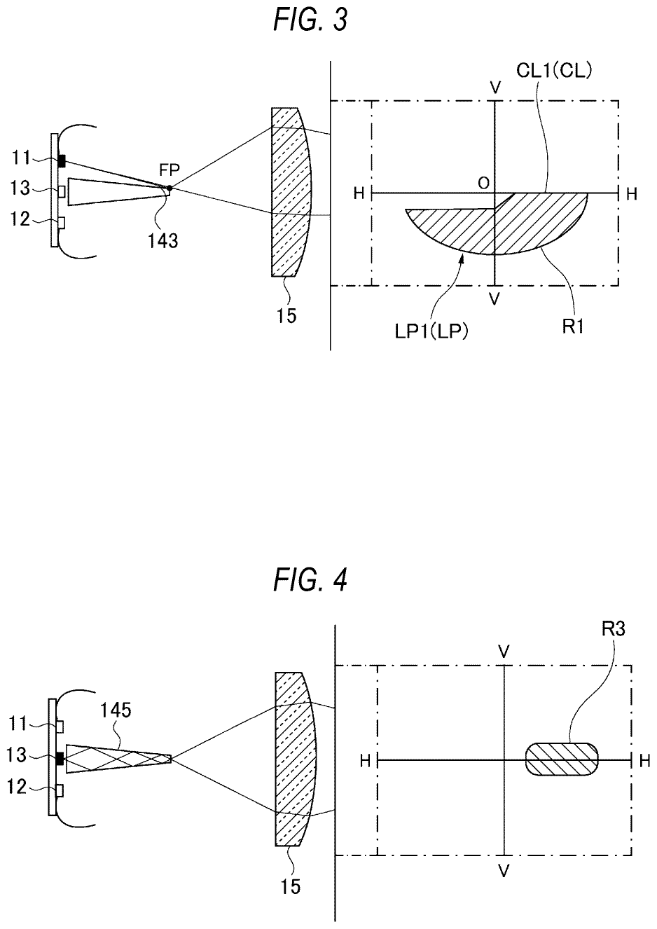

The low light source 11 is configured to emit a low beam light distribution pattern LP (see FIG. 3) having a cutoff line CL extending in the left-right direction. The low light source 11 is, for example, a light emitting diode (LED) element or a laser diode (LD) element. The low light source 11 is an example of a first light source.

The additional light source 13 is configured to cause light to be incident on the optical unit 14 and irradiates a position overlapping the cutoff line CL. The additional light source 13 is, for example, a light emitting diode (LED) element or a laser diode (LD) element.

The low light source 11 and the additional light source 13 are mounted on the common base 19.

The projection lens 15 is configured to refract light emitted from each light source such that a desired region is irradiated with the light. The projection lens 15 has a front surface 15F and a back surface 15B located opposite to the front surface 15F. The front surface 15F is formed of a spherical surface having a single curvature. The back surface 15B is formed of a flat surface.

The first reflector 17 is configured to reflect the light emitted from the low light source 11 toward the projection lens 15. The first reflector 17 has an ellipsoidal first reflection surface 171. The low light source 11 is provided at a first focal position of the elliptical first reflection surface 171. A second focal position of the first reflection surface 171 substantially coincides with a focal position of a lens surface of the front surface 15F of the projection lens 15 (the position of a focal point FP of the front surface 15F of the projection lens 15). Further, a shade portion 143 to be described later is located in the vicinity of the second focal position of the first reflection surface 171.

The first reflector 17 is attached to the base 19 on which the low light source 11 and the additional light source 13 are mounted. In the present embodiment, the first reflector 17, the low light source 11, and the additional light source 13 are arranged on the base 19 in this order in the upper-lower direction (from upper to lower).

Next, the optical unit 14 will be described with reference to FIGS. 1 and 2.

FIG. 2 is a front view of the optical unit 14 as viewed from an arrow II in FIG. 1. As shown in FIGS. 1 and 2, the optical unit 14 extends in the horizontal direction and the front-rear direction. The optical unit 14 is an example of an optical member.

The optical unit 14 includes a light guide portion 145 and a low light blocking portion 141. The light guide portion 145 is configured to guide the light from the additional light source 13. The low light blocking portion 141 is configured to block light emitted from the low light source 11 from entering the light guide portion 145. The low light blocking portion 141 is, for example, a vapor deposition film formed on a front surface of the optical unit 14. The low light blocking portion 141 is an example of a first light blocking portion.

The shade portion 143 is provided at an end portion of the low light blocking portion 141 on the projection lens 15 side and near the focal point FP of the projection lens 15. The shade portion 143 is configured to block a part of the light emitted from the low light source 11 and incident on the projection lens 15, and to form the cutoff line CL in a light distribution pattern.

An emission surface 146 of the light guide portion 145 is provided in the vicinity of the shade portion 143 so as to face the projection lens 15. In other words, the emission surface 146 is also provided at the end portion of the optical unit 14 on the projection lens 15 side.

At least a part of the light emitted from the additional light source 13 passes through the light guide portion 145 and is emitted from the emission surface 146 so as to overlap the cutoff line CL. Further, the emission surface 146 has a shape corresponding to the cutoff line CL (FIG. 2). In the present embodiment, the emission surface 146 has a first flat surface 147, a second flat surface 148, and a third flat surface 149.

The first flat surface 147 extends in the horizontal direction and is located to the right of the emission surface 146. The third flat surface 149 extends in the horizontal direction and is located to the left of the emission surface 146. In the upper-lower direction, the positions of the first flat surface 147 and the third flat surface 149 are the same.

The second flat surface 148 extends in the horizontal direction and is located between the first flat surface 147 and the third flat surface 149. A flat portion 148M of the second flat surface 148 is located higher than the first flat surface 147 and the third flat surface 149. The second flat surface 148 has a right inclined portion 148R on a right end portion and a left inclined portion 148L on the left side. The right inclined portion 148R is connected to the first flat surface 147. A connection portion between the first flat surface 147 and the right inclined portion 148R corresponds to a V-V line at the center of an irradiation range of the vehicle headlamp 10, which will be described later. The left inclined portion 148L is connected to the third flat surface 149.

Next, a light distribution pattern emitted by the vehicle headlamp 10 will be described with reference to FIGS. 3 to 5. FIGS. 3 to 5 are diagrams illustrating light distribution patterns that can be formed when each light source is turned on. These light distribution patterns can be formed on a virtual screen in front of the vehicle 1 (for example, 25 m ahead). FIGS. 3 to 5 illustrate a line V-V indicating a vertical direction (the upper-lower direction on a virtual screen in each drawing) at the center of the irradiation range of the vehicle headlamp 10, and a line H-H orthogonal to the line V-V and extending in the horizontal direction (the left-right direction on the virtual screen in each drawing).

FIG. 3 is a diagram illustrating a first irradiation region R1 formed when the low light source 11 of the vehicle headlamp 10 is turned on. As shown in FIG. 3, when the low light source 11 is turned on, a part of the light emitted from the low light source 11 is blocked by the shade portion 143. Therefore, a cutoff line CL1 extending in the left-right direction and having a relatively large contrast ratio between brightness and darkness is formed. On the other hand, another part of the light emitted from the low light source 11 is emitted via the projection lens 15 onto a region including a region below the cutoff line CL1. As described above, when the low light source 11 is turned on, light is emitted onto the first irradiation region R1 that has a relatively sharp and clear cutoff line CL1. In the following description, the first irradiation region R1 may be referred to as a first low beam light distribution pattern LP1.

FIG. 4 is a diagram illustrating a third irradiation region R3 formed when the additional light source 13 of the vehicle headlamp 10 is turned on. As illustrated in FIG. 4, when the additional light source 13 is turned on, the light emitted from the additional light source 13 passes through the light guide portion 145 of the optical unit 14 and is guided to the projection lens 15. The light that has passed through the projection lens 15 is emitted to a position that overlaps the cutoff line CL. The light guide portion 145 extends in the left-right direction, and therefore the light emitted from the additional light source 13 is diffused in the left-right direction as it passes through the light guide portion 145. The third irradiation region R3 is longer in the left-right direction than in the upper-lower direction.

Unlike the light emitted from the low light source 11, the light emitted from the additional light source 13 is directly incident on the light guide portion 145 of the optical unit 14 without passing through the first reflector 17 having the first reflection surface 171 which is an ellipsoidal surface. Therefore, a degree of concentration of the light emitted from the additional light source 13 is low. Therefore, compared with the cutoff line CL1 of the first irradiation region RI formed by the light emitted from the low light source 11, an outline of the third irradiation region R3 formed by the light emitted from the additional light source 13 is blurred.

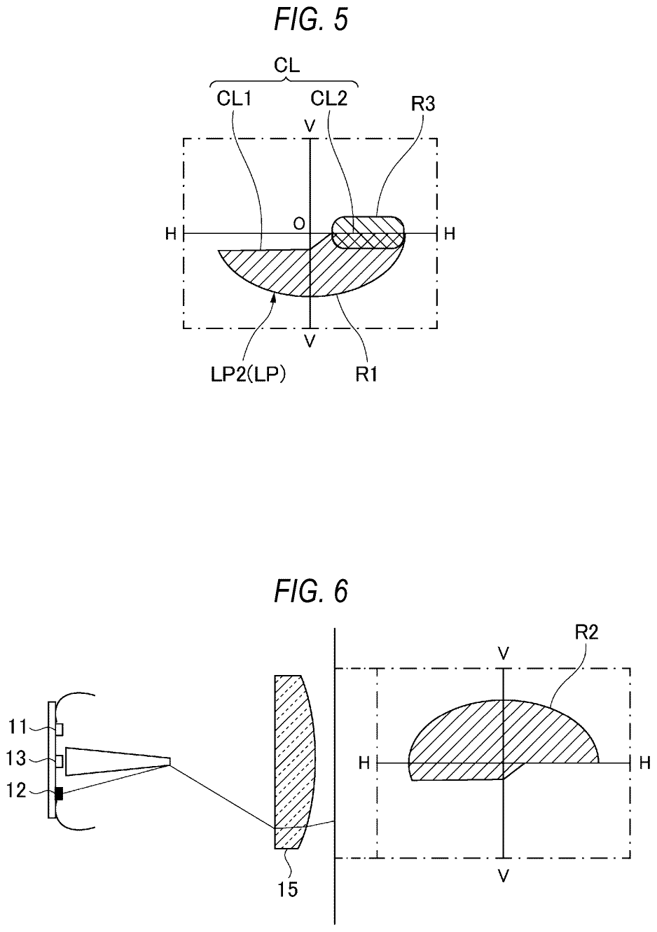

FIG. 5 is a diagram illustrating an irradiation region formed when the low light source 11 and the additional light source 13 of the vehicle headlamp 10 are turned on. As shown in FIG. 5, when the low light source 11 and the additional light source 13 are turned on, the first irradiation region RI and the third irradiation region R3 are illuminated. In this way, the vehicle headlamp 10 according to the present embodiment can emit a second low beam light distribution pattern LP2 shown in FIG. 5. That is, when the second low beam light distribution pattern LP2 is emitted, the low light source 11 and the additional light source 13 are turned on.

In the second low beam light distribution pattern LP2, a third irradiation region R3 having a blurred outline is emitted to a position overlapping the cutoff line CL. Therefore, the cutoff line CL is blurred as compared with the first low beam light distribution pattern LP1 when only the low light source 11 is turned on. As described above, the vehicle headlamp 10 according to the present embodiment can form the second low beam light distribution pattern LP2 having the blurred cutoff line CL2.

As described above, the vehicle headlamp 10 according to the present embodiment includes the optical unit 14 (optical member) extending in the horizontal direction and the front-rear direction, the low light source 11 (first light source), the additional light source 13 (second light source) configured to cause light to be incident on the optical unit 14, and the projection lens 15. The optical unit 14 includes the light guide portion 145 configured to guides light from the additional light source 13, and the low light blocking portion 141 configured to block the light emitted from the low light source 11 from entering the light guide portion 145. The shade portion 143, which is configured to block a part of the light emitted from the low light source 11 and incident on the projection lens 15 to form the cutoff line CL in a light distribution pattern, is provided at the end portion of the low light blocking portion 141 on the projection lens 15 side, near the focal point of the projection lens 15. The emission surface 146 of the light guide portion 145 is provided in the vicinity of the shade portion 143 so as to face the projection lens 15. At least a part of the light emitted from the additional light source 13 is emitted so as to overlap the cutoff line CL.

According to such a configuration, the optical unit 14 has the light guide portion 145 that guides the light from the additional light source 13, and the shade portion 143 that forms the cutoff line CL in a light distribution pattern. Since the light guide portion 145 is integrally formed with the shade portion 143, an increase in the number of components is prevented. The emission surface 146 of the light guide portion 145 is provided near the shade portion 143. Therefore, it is easy to emit the light from the additional light source 13 to overlap the cutoff line CL.

When both the low light source 11 and the additional light source 13 are turned on, the second low beam light distribution pattern LP2 having the blurred cutoff line CL2 can be emitted, and when only the low light source 11 is turned on, the first low beam light distribution pattern LP1 having the clear cutoff line CL1 is emitted. As described above, the vehicle headlamp 10 according to the present embodiment can easily switch between the first low beam light distribution pattern LP1 and the second low beam light distribution pattern LP2.

The emission surface 146 of the light guide portion 145 has a shape corresponding to the cutoff line CL. Therefore, it becomes easier to emit the light from the additional light source 13 to overlap the cutoff line CL.

The emission surface 146 of the present embodiment includes the first flat surface 147, the second flat surface 148, and the third flat surface 149, and the connection portion between the first flat surface 147 and the left inclined portion 148L of the second flat surface corresponds to the V-V line at the center of the irradiation range of the vehicle headlamp 10. Therefore, it is possible to reduce glare to a traffic participant in the right front of the vehicle 1.

Since the front surface of the optical unit 14 functions as the low light blocking portion 141 and the shade portion 143, the emission surface 146 of the light guide portion 145 is preferably disposed at a position as close as possible to the shade portion 143. If the low light blocking portion 141 is formed of a thick member such as a metal plate, the emission surface 146 is supposed to be separated from the shade portion 143. However, in the present embodiment, the low light blocking portion 141 is a vapor deposition film formed on the front surface of the optical unit 14. Since the low light blocking portion 141 is formed of the vapor deposition film, the emission surface 146 can be disposed at a position close to the shade portion 143.

The vehicle headlamp 10 illustrated in FIG. 1 includes a third light source (high light source 12) on an opposite side of the first light source with respect to the optical member, and light emitted from the third light source is projected above the cutoff line by the projection lens. More specifically, the high light source 12 is attached to the base 19 on which the low light source 11 and the additional light source 13 are mounted. In the upper-lower direction (from upper to lower), the low light source 11, the additional light source 13, and the high light source 12 are arranged on the base 19 in this order.

The high light source 12 irradiates a region above the cutoff line CL with light. The high light source 12 includes, for example, a plurality of micro LED light emitting elements. The light emission states of the plurality of micro LED light emitting elements can be changed independently of each other. That is, the vehicle headlamp 10 can perform ON/OFF control and brightness adjustment for each of the micro LED light emitting elements included in the high light source 12.

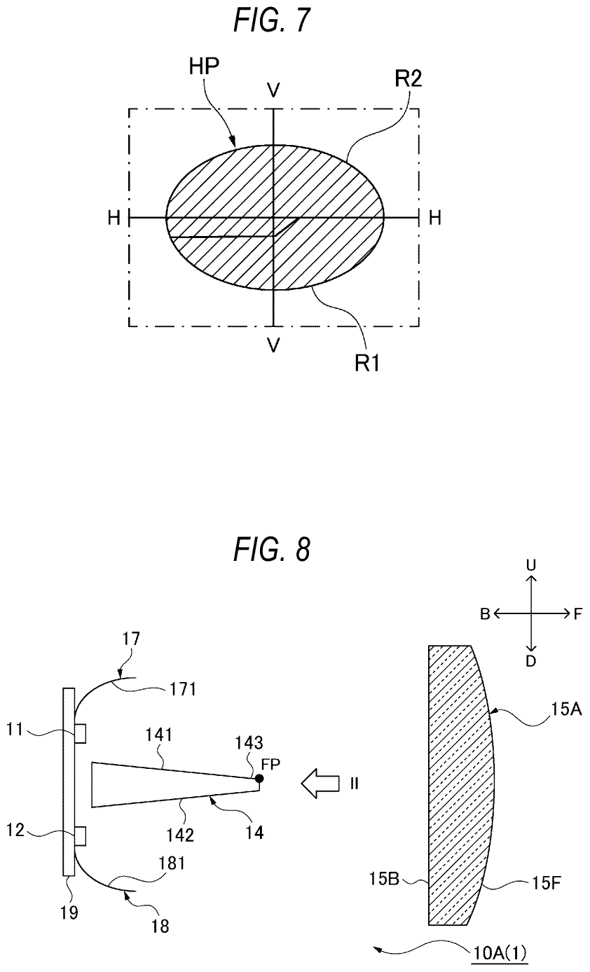

Next, a light distribution pattern emitted by the high light source 12 of the vehicle headlamp 10 will be described with reference to FIGS. 6 and 7. In the configuration illustrated in FIGS. 6 and 7, the same reference numerals are given to the same configurations as those illustrated in FIG. 3, and the description thereof will be omitted.

FIG. 6 is a diagram illustrating a second irradiation region R2 formed when the high light source 12 of the vehicle headlamp 10 is turned on. As illustrated in FIG. 6, when the high light source 12 is turned on, the light emitted from the high light source 12 is projected by the projection lens 15 onto a region including a region above the cutoff line CL. As described above, when the high light source 12 is turned on, the region including the region above the cutoff line CL is irradiated with light.

FIG. 7 is a diagram illustrating an irradiation region formed when the low light source 11 and the high light source 12 of the vehicle headlamp 10 are turned on. As illustrated in FIG. 7, when the low light source 11 and the high light source 12 are turned on, the irradiation region illustrated in FIG. 3 and the irradiation region illustrated in FIG. 6 are combined. In this way, a high beam light distribution pattern HP having the region including the region below the cutoff line CL and the region including the region above the cutoff line CL is formed.

As described above, the vehicle headlamp 10 further includes the high light source 12 provided on the opposite side of the low light source 11 with respect to the optical unit 14. The light emitted from the high light source 12 is projected above the cutoff line CL by the projection lens 15. When both the low light source 11 and the high light source 12 are turned on, the high beam light distribution pattern HP is emitted. As described above, the vehicle headlamp 10 can emit not only the low beam light distribution pattern LP but also the high beam light distribution pattern HP.

In addition to the low light blocking portion 141 (first light blocking portion) and the light guide portion 145, the optical unit 14 includes a high light blocking portion 142 (third light blocking portion) configured to block light emitted from the high light source 12 from entering the light guide portion 145. The high light blocking portion 142 is, for example, a vapor deposition film formed on the front surface of the optical unit 14. The light guide portion 145 is located between the low light blocking portion 141 and the high light blocking portion 142, and the emission surface 146 of the light guide portion 145 is exposed between the low light blocking portion 141 and the high light blocking portion 142. As described above, the light guide portion 145 that guides the light from the additional light source 13 and the emission surface 146 of the light guide portion 145 are disposed between the two light blocking portions (the low light blocking portion 141 and the high light blocking portion 142) that block the light from each of the low light source 11 and the high light source 12, so that an increase in size of the vehicle headlamp 10 is prevented.

The vehicle headlamp 10 described above can also be expressed as follows.

The vehicle headlamp 10 is capable of emitting a light distribution pattern having the cutoff line CL. The vehicle headlamp 10 includes the low light source 11 (first light source), the high light source 12 (second light source), the optical unit 14 (partition unit) that separates the low light source 11 and the high light source 12, and the projection lens 15. The optical unit 14 includes the additional light source 13 (third light source), the light guide portion 145 configured to guide light from the additional light source 13 to the projection lens 15, the low light blocking portion 141 (first light blocking portion) that is provided on the low light source 11 side of the light guide portion 145 (upper surface of the optical unit 14 in FIG. 2) and is configured to block incidence of light from the low light source 11 to the light guide portion 145, and the high light blocking portion 142 (second light blocking portion) that is provided on the high light source 12 side of the light guide portion 145 (lower surface of the optical unit 14 in FIG. 2) and is configured to block incidence of light from the high light source 12 to the light guide portion 145. At the end portion of the optical unit 14 on the projection lens 15 side, the emission surface 146 of the light guide portion 145 having a shape corresponding to the cutoff line CL is exposed between the low light blocking portion 141 and the high light blocking portion 142, and the light emitted from the additional light source 13 is emitted at least at a position overlapping the cutoff line CL.

According to such a configuration, the light guide portion 145 that guides the light from the additional light source 13 is disposed in the optical unit 14 that blocks the light emitted from each of the low light source 11 and the high light source 12. Therefore, an increase in size of the vehicle headlamp 10 is prevented. Further, the emission surface 146 of the light guide portion 145 is provided in the vicinity of the focal point FP of the projection lens 15, so that the shape of the emission surface 146 can directly become the shape of the light distribution pattern formed by the light emitted from the additional light source 13. Therefore, by forming the emission surface 146 of the light guide portion 145 in a shape corresponding to the cutoff line CL, a light distribution pattern that overlaps the cutoff line CL is easily formed by the light emitted from the additional light source 13.

The shade portion 143, which blocks a part of the light emitted from the low light source 11 and incident on the projection lens 15, is provided at the end portion of the low light blocking portion 141 on the projection lens 15 side, near the focal point FP of the projection lens 15. Therefore, the cutoff line CL can be formed in the light distribution pattern.

The emission surface 146 of the light guide portion 145 is provided in the vicinity of the shade portion 143 so as to face the projection lens 15. Therefore, it is easy to emit the light from the additional light source 13 to overlap the cutoff line CL.

The low light source 11, the additional light source 13, and the high light source 12 are mounted on the common base 19. Since the plurality of light sources are unitized by the base 19, assembly is easy.

The vehicle headlamp 10 includes a second reflector 18 in addition to the first reflector 17. The first reflector 17 configured to reflect light emitted from the low light source 11 toward the projection lens 15 and the second reflector 18 configured to reflect light emitted from the high light source 12 toward the projection lens 15 are fixed to the common base 19.

The second reflector 18 has an ellipsoidal second reflection surface 181. The high light source 12 is provided at a first focal position of the second reflection surface 181. A second focal position of the second reflection surface 181 does not coincide with the focal position of the lens surface of the front surface 15F of the projection lens 15.

The second reflector 18 is also attached to the base 19. In the present embodiment, the first reflector 17, the low light source 11, the additional light source 13, the high light source 12, and the second reflector 18 are arranged on the base 19 in this order in the upper-lower direction (from upper to lower). Since the two reflectors are unitized by the base 19 together with the plurality of light sources, assembly is easier.

The vehicle headlamp 10 according to the present embodiment can emit, for example, an adaptive driving beam (ADB) light distribution pattern. The ADB light distribution pattern is a light distribution pattern in which a region where an object such as a preceding vehicle or an oncoming vehicle is present is not irradiated with light in the high beam light distribution pattern HP, and is a light distribution pattern in which a non-irradiation region is changed depending on the presence or absence and the position of the object. The vehicle headlamp 10 can dim any region above the cutoff line CL by performing ON/OFF control and brightness adjustment for each of the micro LED light emitting elements constituting the high light source 12, and can emit an ADB light distribution pattern. In the present specification, the term “dim” includes at least one of blocking at least a part of the light emitted from the high light source 12 and reducing the intensity of the light emitted from the high light source 12.

Although the embodiments of the present disclosure have been described above, it is needless to say that the technical scope of the present disclosure should not be construed as being limited by the description of the embodiments. The present embodiment is merely an example, and it will be obvious to those skilled in the art that various embodiments can be changed within the scope of the disclosure described in the claims. The technical scope of the present disclosure is determined based on the scope of the disclosure described in the claims and the equivalent scope thereof.

In the embodiment described above, the projection lens 15 may have a plurality of portions that guide the light emitted from each light source. The projection lens 15 may include a first portion 151, a second portion 152, and a third portion 153 (FIG. 1). The first portion 151 is configured to guide the light emitted from the low light source 11 below the cutoff line CL. The second portion 152 is configured to guide the light emitted from the high light source 12 above the cutoff line CL. The third portion 153 is configured to guide the light emitted from the additional light source 13 to a position that overlaps the cutoff line CL. Each of the first portion 151, the second portion 152, and the third portion 153 is formed as an uneven shape provided on one surface of the projection lens 15. The portions may be formed as an uneven shape provided on one surface of the projection lens 15. For example, the first portion 151, the second portion 152, and the third portion 153 may be configured as textured portions provided on the front surface 15F or the back surface 15B of the projection lens 15. The textured portion may be formed by minute irregularities provided on the front surface 15F or the back surface 15B of the projection lens 15.

Further, such textured portions (uneven shape) may be formed asymmetrically in the horizontal direction. For example, the degree of diffusion may be different between a right portion and a left portion of the front surface 15F of the projection lens 15. When the textured portion is configured to guide the light that has passed therethrough onto the cutoff line CL, as shown in FIG. 5, it is possible to form the low beam light distribution pattern LP with different degrees of blurring in a region on the right side and a region on the left side of a point O of the cutoff line CL.

### MODIFICATIONS

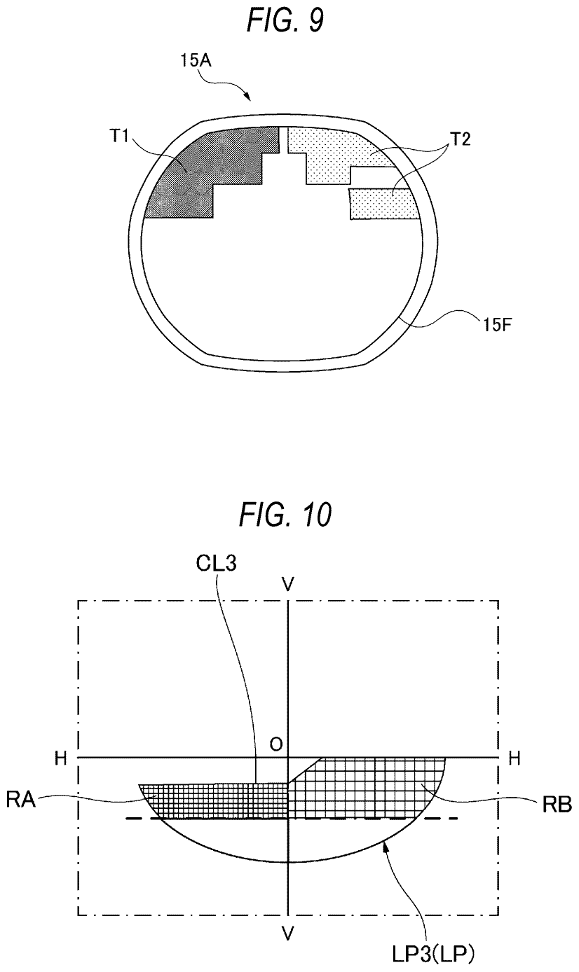

A vehicle headlamp 10A according to a modification will be described with reference to FIGS. 8 and 9. FIG. 8 is a cross-sectional view illustrating a configuration of a vehicle headlamp 10A according to a modification. In the configuration illustrated in FIG. 8, the same components as those illustrated in FIG. 1 are denoted by the same reference numerals, and the description thereof is omitted.

As illustrated in FIG. 8, unlike the vehicle headlamp 10 according to the above-described embodiment, the vehicle headlamp 10A according to the present modification does not include the additional light source 13, the light guide portion 145, or the emission surface 146.

FIG. 9 is a front view of a projection lens 15A. As shown in FIG. 9, a first textured portion T1 and a second textured portion T2 are provided on a front surface of the projection lens 15A. Each of the textured portions is formed of minute irregularities provided on the front surface 15F of the projection lens 15A. Each of the textured portions refracts light passing therethrough in a desired direction.

The first textured portion T1 is provided in an upper left region (an upper right region when viewed from the line of sight of a driver of the vehicle 1) of the front surface 15F in a front view of the projection lens 15A. The first textured portion T1 is provided to the left of the center line of the projection lens 15A in the left-right direction. The second textured portion T2 is provided in an upper right region (an upper left region when viewed from the line of sight of a driver of the vehicle 1) of the front surface 15F in the front view of the projection lens 15A. The second textured portion T2 is provided to the right of the center line of the projection lens 15A in the left-right direction.

FIG. 10 is a diagram illustrating a third low beam light distribution pattern LP3 emitted by the vehicle headlamp 10A according to the modification. The vehicle headlamp 10A according to the present modification will be described as a vehicle headlamp mounted on the vehicle 1 that travels in an area where the right lane is the driving lane.

In this example, in an upper portion of the third low beam light distribution pattern LP3 including the cutoff line CL, a first region RA on the left side of the line V-V is irradiated with the light that has passed through the first textured portion T1. Further, in the upper portion of the third low beam light distribution pattern LP3 including the cutoff line CL, a second region RB on the right side of the line V-V is irradiated with the light that has passed through the second textured portion T2.

The first textured portion T1 and the second textured portion T2 are configured such that light passing through the second textured portion T2 is more diffused than light passing through the first textured portion T1. For example, the degree of diffusion of light passing through the textured portions can be adjusted by varying the size or density of the unevenness. Therefore, as shown in FIG. 10, it is possible to form the third low beam light distribution pattern LP3 having a cutoff line CL3 with different degrees of blurring between the right side and the left side of the point O.

According to the vehicle headlamp 10A of the present modification, the first textured portion T1 and the second textured portion T2 having different degrees of diffusion are provided in the left-right direction on at least one of the front surface 15F and the back surface 15B of the projection lens 15A. With such a simple configuration, it is possible to form the third low beam light distribution pattern LP3 having the cutoff line CL3 with different degrees of blurring between the right side and the left side of the point O. In this case, it is not necessary to mount the additional light source 13 as in the above-described embodiment.

The present application claims the priority based on Japanese patent application No. 2023-053554 filed on Mar. 29, 2023, and all the contents described in the Japanese patent application are incorporated.

1. A vehicle headlamp comprising:
an optical member that extends in a horizontal direction and a front-rear direction;
a first light source;
a second light source configured to cause light to be incident on the optical member; and
a projection lens,
wherein the optical member includes:
a light guide portion configured to guide light from the second light source; and
a first light blocking portion configured to block light emitted from the first light source from entering the light guide portion,
wherein a shade portion is provided at an end portion of the first light blocking portion on the projection lens side and near a focal point of the projection lens, the shade portion being configured to block a part of the light emitted from the first light source and incident on the projection lens to form a cutoff line in a light distribution pattern, and
wherein an emission surface of the light guide portion is provided near the shade portion so as to face the projection lens, and at least a part of light emitted from the second light source is emitted so as to overlap the cutoff line.

2. The vehicle headlamp according to claim 1, further comprising:
a third light source provided on an opposite side of the first light source with respect to the optical member,
wherein light emitted from the third light source is projected above the cutoff line through the projection lens.

3. The vehicle headlamp according to claim 2,
wherein the optical member includes a third light blocking portion configured to block light emitted from the third light source from entering the light guide portion, and
wherein the emission surface of the light guide portion is exposed between the first light blocking portion and the third light blocking portion.

4. The vehicle headlamp according to claim 1, wherein the emission surface of the light guide portion has a shape corresponding to the cutoff line.

5. The vehicle headlamp according to claim 1, wherein the first light blocking portion is a vapor deposition film formed on a front surface of the optical member.

6. A vehicle headlamp for emitting a light distribution pattern having a cutoff line, the vehicle headlamp comprising:
a first light source;
a second light source;
a partition unit that separates the first light source and the second light source; and
a projection lens,
wherein the partition unit includes:
a third light source;
a light guide portion configured to guide light from the third light source to the projection lens;
a first light blocking portion that is provided on the first light source side of the light guide portion and that is configured to block light from the first light source from entering the light guide portion; and
a second light blocking portion that is provided on the second light source side of the light guide portion and that is configured to block light from the second light source from entering the light guide portion; and
wherein at an end portion of the partition unit on the projection lens side, an emission surface of the light guide portion having a shape corresponding to the cutoff line is exposed between the first light blocking portion and the second light blocking portion, and light emitted from the third light source is emitted at least at a position overlapping the cutoff line.

7. The vehicle headlamp according to claim 6, wherein a shade portion is provided at an end portion of the first light blocking portion on the projection lens side and near a focal point of the projection lens, the shade portion being configured to block a part of light emitted from the first light source and incident on the projection lens to form the cutoff line in a light distribution pattern.

8. The vehicle headlamp according to claim 7, wherein the emission surface of the light guide portion is provided near the shade portion so as to face the projection lens.

9. The vehicle headlamp according to claim 6, wherein the first light source, the second light source, and the third light source are mounted on a common base.

10. The vehicle headlamp according to claim 9, wherein a first reflector configured to reflect light emitted from the first light source toward the projection lens and a second reflector configured to reflect light emitted from the second light source toward the projection lens are fixed to the common base.

11. The vehicle headlamp according to claim 6, wherein the first light blocking portion is a vapor deposition film formed on a front surface of the partition unit.

12. The vehicle headlamp according to claim 6, wherein the projection lens includes:
a first portion configured to guide light emitted from the first light source below the cutoff line;
a second portion configured to guide light emitted from the second light source above the cutoff line; and
a third portion configured to guide light emitted from the third light source to a position that overlaps the cutoff line, and
wherein each of the first portion, the second portion, and the third portion is formed as an uneven shape provided on one surface of the projection lens.

13. The vehicle headlamp according to claim 12, wherein the uneven shape is formed asymmetrically in a horizontal direction.
